(19) United States
(12) Patent Application Publication
(10) Pub. No.: US 2026/0070271 A1
(43) Pub. Date: Mar. 12, 2026

(54) METAL-PLASTIC HYBRID MATERIALS WITH STEEL AND/OR ZINC AND/OR ALLOYS THEREOF AS METAL COMPONENT

(71) Applicant: CHEMETALL GMBH, Frankfurt (DE)

(72) Inventors: Nawel Souad KHELFALLAH, Frankfurt (DE); Gerrit SCHUELLERMANN, Frankfurt (DE); Philippe DESBOIS, Ludwigshafen (DE); Rui DE OLIVEIRA, Ludwigshafen (DE)

(21) Appl. No.: 19/108,241

(22) PCT Filed: Sep. 21, 2023
(86) PCT No.: PCT/EP23/76067

§ 371 Date: Mar. 3, 2025

(30) Foreign Application Priority Data
Sep. 23, 2022 (EP) 22197351.4

(51) Int. Cl. B29C 45/14; B29K 33/00; B29K 705/12; B32B 15/082; B32B 15/18

(52) U.S. Cl. CPC B29C 45/14311; B32B 15/082; B32B 15/18; B29C 2045/14868; B29K 2033/08; B29K 2705/12; B32B 2250/02; B32B 2311/20; B32B 2311/30

(57) ABSTRACT

Described herein is a method for preparing a metal-plastic hybrid material, the material including at least one substrate having at least one metallic surface made at least partially of steel and/or zinc and/or of an alloy thereof and at least one thermoplastic material applied onto the metallic surface of the substrate, inter alia by making use of an acidic aqueous composition. Also described herein are a metal-plastic hybrid material obtainable by this method, a use of the acidic aqueous composition for adhering the substrate to the plastic, a metal-plastic hybrid material, and a use of the metal-plastic hybrid material as a component in the automotive or construction industry.

The present invention relates to a method for preparing a metal-plastic hybrid material, said material comprising at least one substrate having at least one metallic surface made at least partially of steel and/or zinc and/or of an alloy thereof and at least one thermoplastic material applied onto said metallic surface of the substrate, inter alia by making use of an acidic aqueous composition, a metal-plastic hybrid material obtainable by this method, a use of a water-soluble polymer, preferably when present in the acidic aqueous composition, for adhering the substrate to the plastic, a metal-plastic hybrid material as such, and a use of the metal-plastic hybrid material as component in the automotive or construction industry.

### BACKGROUND OF THE INVENTION

Metal-plastic hybrid materials are one of the solutions proposed to reduce weight, either in parts such as structural parts used in the automotive industry or in other components, such as covers for battery materials, elements of powertrain, control panels etc. To obtain such parts and components, plastics and metals can be joined together in several ways to develop bonded materials with the ideal combination of characteristics of both materials, metal and plastic. Joining dissimilar materials such as metal and plastic is, however, very challenging not only because of the different chemical natures of both materials and, hence, of their surfaces, but also due to the shrinkage of the plastic materials such as thermoplastic materials, which is observed, e.g., upon molding, resulting from the dissimilarity of both materials.

Conventionally, an adhesive is used to bind a metal to a thermoplastic material. However, a method of producing such a product using an adhesive not only increases the number of production steps, but also the adhesive strength may decrease with time or integrating strength may not be exhibited at high temperatures. Therefore, applying such a method in technical fields such as the automotive industry, is not suitable-independently of the economic and ecological disadvantages associated therewith-, since here often a significant heat resistance is required because of electrodeposition and painting processes.

Joining galvanized steel such as hot-dip galvanized steel (HDG) to thermoplastic materials without using an adhesive is, however, very challenging. In contrast to aluminum materials, where controlled etching or anodizing methods have been used to inject plastic directly onto the metal surface, such methods cannot be applied to materials made of or comprising galvanized steel such as HDG. Plasma technology may be been used for this purpose, but the treated metal surface in this case is limited to only a small portion, due to the equipment and other constraints. Furthermore, the surface is activated only for few hours, which also undesirably limits such a process.

It is known to apply a polymer plastic film on galvanized steel by means of lamination, in particular in form of a polymer-metal laminate or in form of a sandwich material or sandwich structure, wherein a polymer plastic is sandwiched between two metal substrates. Examples of sandwich structures and laminates in general are, e.g., disclosed in WO 2016/83083 A1 and WO 2017/125261 A1 as well as in WO 2017/098060 A, WO 2017/098061 A1, US 2015/314563 A1 and US 2019/022797 A1: WO 2016/83083 A1 relates to a product comprising at least one first metal layer and at least one plastics layer, which are joined over their full area to one another to form a metal/plastic composite and to a method for producing such a product, wherein the visible surface of the metal layer of the metal/plastic composite has a coil coating. WO 2017/125261 A1 discloses a method for producing a composite material having at least two layers of a metallic material and at least one layer of a polymer matrix material arranged between the two layers. WO 2017/098060 A1 and WO 2017/098061 A1 relate to a method for producing a product, in which a metal support designed as sheet metal or plate covered with at least one prepreg having a thermally crosslinkable, duroplastic matrix with continuous fibers, is formed into the product by deep drawing, stretch deep drawing or roll profiling after the duroplastic matrix of the prepreg has been pre-crosslinked by heating. US 2015/314563 A1 discloses a laminated core and a method for connecting sheet metal parts to form a laminated core, wherein sheet metal parts are separated from a sheet metal strip having a layer of curable polymer adhesive, and the sheet metal parts with adhesive-coated sides facing one another are provided above one another and are bonded under pressure to form a laminated core. US 2019/022797 A1 relates to a method for producing a plastic-metal hybrid component made from a metal surface of a metal base body provided with a corrosion protection layer, which has a surface having undercuts applied by making use of a filler material. These undercuts are then at least partially filled with a thermoplastic plastic component in such a way that the latter engages in the undercuts, forming the plastic-metal hybrid component.

Further sandwich structures as mentioned above are disclosed in WO 2018/145981 A1 and WO 2015/181004 A1: WO 2018/145981 A1 discloses a composite material comprising two metal sheets connected by means of a thermoplastic polymeric film and an adhesion promoter layer disposed between the respective sheets and the film. The aqueous adhesion promoter composition used for providing the layer comprises a polymer selected from maleic acid/polyacrylic acid copolymer and (modified) polyacrylic acid and a phosphate component. WO 2015/181004 A1 discloses a method for producing a sandwich structure, wherein the metallic surface is brought into contact with an aqueous conversion composition comprising inter alia zinc cations, phosphate and a polyacrylic acid and the resulting coated dried metallic surface is then brought into contact with a layer of an organic polymer and the desired sandwich structure is formed by means of compaction under pressure and/or temperature.

For providing polymer-metal laminates and the aforementioned sandwich materials, it is generally necessary to use a plastic material such as a thermoplastic material having a relatively low melting temperature, e.g., polyethylene (PE) or polyethylene terephthalate (PET). Hence, conventional methods for manufacturing the aforementioned products are limited by the necessary polymer characteristics and are, e.g., usually not applicable to plastics and thermoplastic materials having a high melting temperature such as, e.g., polyamide 6 as such in pure form, which is not easy to process for these reasons.

Thus, there is a need to provide metal-plastic hybrid materials and a method for preparing them, which materials contain steel and/or zinc and/or an alloy thereof as metal component, have excellent and permanent or at least long-lasting adhesion properties as far as the adhesion between metal and plastic is concerned, but which at the same time can be prepared without the necessity of using conventional adhesives, which materials further allow a broader spectrum of thermoplastic polymeric materials to be used than in conventional lamination processes for preparing metal-plastic hybrid materials, in particular which allow a use of thermoplastic materials having melting temperatures above 200° C., and which can be further prepared in a flexible, facilitated and ecologically and economically advantageous manner.

### Problem

It has been therefore an objective underlying the present invention to provide metal-plastic hybrid materials and a method for preparing them, which materials contain steel and/or zinc and/or an alloy thereof as metal component, have excellent and permanent or at least long-lasting adhesion properties as far as the adhesion between metal and plastic is concerned, but which at the same time can be prepared without the necessity of using conventional adhesives, which materials further allow a broader spectrum of thermoplastic polymeric materials to be used than in conventional lamination processes for preparing metal-plastic hybrid materials, in particular which allow a use of thermoplastic materials having melting temperatures above 200° C., and which can be further prepared in a flexible, facilitated and ecologically and economically advantageous manner.

### Solution

This objective has been solved by the subject-matter of the claims of the present application as well as by the preferred embodiments thereof disclosed in this specification, i.e., by the subject matter described herein.

A first subject-matter of the present invention is a method for preparing a metal-plastic hybrid material, said material comprising a substrate having at least one metallic surface and at least one thermoplastic material applied onto said metallic surface of the substrate, the method comprising at least steps 1) and 3) and optionally step 2), namely
1) applying an aqueous acidic composition at least in portion onto the at least one metallic surface of the substrate to form a film at least in portion on said surface,
   wherein the metallic surface is made at least partially of at least one kind of steel and/or zinc and/or of at least one alloy thereof, and
   wherein the acidic aqueous composition comprises, besides water, at least one water-soluble polymer having least one kind of functional groups selected from acid groups, hydroxyl groups, amino groups, and mixtures thereof as at least one constituent a1),
and optionally drying or curing the film to form a dried or cured layer,
2) optionally applying at least one thermoplastic polymeric material TM1 in form of a foil at least in portion onto the film or onto the dried or cured layer obtained after step 1), and
3) injecting at least one thermoplastic polymeric material TM2, which is identical to or different from the thermoplastic material TM1 optionally applied in step 2), and which is present in molten state, at least in portion onto the film or onto the dried or cured layer obtained after step 1) or onto the foil optionally obtained after step 2) to form the metal-plastic hybrid material.

A further subject-matter of the present invention is a metal-plastic hybrid material obtainable by this method.

A further subject-matter of the present invention is a use of the water-soluble polymer as defined hereinbefore as constituent a1) of the acidic aqueous composition, preferably a use of said water-soluble polymer when present in said acidic aqueous composition as defined in connection with step 1) of the method, for adhering a metallic surface made at least partially of steel and/or zinc and/or of at least one alloy thereof of a substrate to a thermoplastic material present on said surface in form of a foil such as a foil being made at least partially of the at least one thermoplastic polymeric material TM1, or applied onto said surface by injection molding such as a thermoplastic polymeric material TM2.

A further subject-matter of the present invention is a metal-plastic hybrid material as such, i.e., a metal-plastic hybrid material comprising
a substrate having at least one metallic surface, which is made at least partially of at least one kind of steel and/or zinc and/or of at least one alloy thereof,
a film or a dried or cured layer applied at least in portion over said metallic surface, the film or dried or cured layer being obtainable from applying the aqueous acidic composition, as defined in connection with aforementioned step 1) of the inventive method, at least in portion onto said metallic surface,
optionally at least one thermoplastic polymeric material TM1 in form of a foil applied at least in portion over the film or the dried or cured layer, preferably as defined in optional step 2) of the inventive method, and
at least one thermoplastic polymeric material TM2 in a form obtainable from an injection molding and applied at least in portion over the film or over the dried or cured layer or, if present, over the foil, preferably as defined in step 3) of the inventive method, the material TM2 being identical to or different from the optionally present thermoplastic polymeric material TM1, wherein the thermoplastic polymeric material TM2 preferably comprises at least one polyamide.

A further subject-matter of the present invention is a use of said metal-plastic hybrid material or of the metal-plastic hybrid material obtainable by the inventive method as component in the automotive or construction industry.

It been found that the inventively used acidic aqueous composition is able to provide a conversion coating on the metallic surface of the substrate and at the same time provides a good adhesion between the metallic surface and the thermoplastic material TM1 or TM2 applied on top of the metallic surface due to the adhesion promoting properties of the conversion coating film or layer formed. It has been found that without application of the acidic aqueous composition, no sufficient adhesion can be obtained. It has been further in particular surprisingly found, that the water-soluble polymer present in the acidic aqueous composition functions as adhesion promoter in this regard. Achieving an excellent adhesion is in particular relevant, since it has been found that the strength of the adhesion layer between the metallic surface and the thermoplastic material used has a significant impact on the lifetime of the metal-plastic hybrid material. Moreover, it has been found that metallic steel and/or zinc and/or of at least one alloy thereof containing surfaces, in particular being at least partially made of galvanized steel, of all kinds of substrates of different shape can be used, in particular of sheets, coils and/or of other shaped substrates.

Further, it has been in particular surprisingly found that the adhesion problems and issues known in the prior art when combining the two dissimilar materials, namely a thermoplastic polymer such as TM2 or TM1 on the one hand, and steel and/or zinc and/or of at least one alloy thereof such as galvanized steel, in particular HDG, on the other hand, can be overcome by the inventive method of preparing a metal-plastic hybrid material, in particular by a combination of step 3), which allows the thermoplastic polymer TM2 to be injected directly onto the metallic surface of the substrate or the foil-containing surface of the substrate, and using the acidic aqueous composition for chemical pretreatment of the metallic surface as illustrated in step 1) of the inventive method prior to performance of step 3). It has been found that the method of preparing the metal-plastic hybrid material in particular allows even using thermoplastic polymers such TM2 with comparably high melting temperatures such as polyamide, in particular polyamide 6, to be applied, directly by injection molding according to step 3) of the inventive method. Injecting a thermoplastic material directly on metallic surface in accordance with step 3) offers many benefits, among them being simplicity, robustness, and a wide application window. Flexibility of the method can be, e.g., achieved as step 1) of the method can be used in coil line by a roll coater or can be sprayed at a job coater, which makes the method highly flexible.

It has also been found that not only an excellent adhesion is achieved, but also a very good protection against corrosion by applying the inventively used acidic aqueous composition.

It has been additionally surprisingly found that the inventive method allows a thermoplastic injection of thermoplastic polymer TM2 directly onto a steel and/or zinc and/or of at least one alloy thereof-containing metallic surface such as a surface made of galvanized steel, despite an only very short contact time between TM2 and the metallic surface, and despite a significant temperature difference between the molten thermoplastic polymer material TM2, which may exceed 200° C., and the substrate temperature of the surface, which usually is room temperature, i.e. in a range of from 18 to 25° C., but may also be heated, e.g., up to 80° C. if needed. It has been found that, in particular, the presence of the functional groups of the water-soluble polymer in the acidic aqueous composition used allow a very quick bonding prior to the cooling of the thermoplastic material once applied/injected.

Moreover, it has been found that using the acidic aqueous composition for chemical pretreatment of the metallic surface as illustrated in step 1) of the inventive method prior to performance of step 3) also provides a strong adhesion to a thermoplastic material TM1, when applied as foil (foil) to the treated metallic surface. It has been found that the foil formed from applying TM1 can then further serve as such as an adhesion layer or an interface layer, onto which the thermoplastic material TM2 is injected in step 3) of the method when performed, in particular when the foil formed in step 2) from TM1 is chemically compatible to material TM2 applied in step 3).

### DETAILED DESCRIPTION OF THE INVENTION

The term “comprising” in the sense of the present invention, in connection for example with the acidic aqueous composition, preferably has the meaning of “consisting of”. With regard, e.g., to the acidic aqueous composition, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in the acidic aqueous composition, add up to 100 wt.-%, based in each case on the total weight of the acidic aqueous composition.

### Inventive Method

A first subject-matter of the present invention is a method for preparing a metal-plastic hybrid material, said material comprising a substrate having at least one metallic surface and at least one thermoplastic material applied onto said metallic surface of the substrate. the method comprising at least steps 1) and 3) and optionally step 2).

The method may comprise further steps besides steps 1) and 3) and optional step 2). For example, a cleaning step of the metallic surface may be performed prior to step 1), e.g., by means of an acidic, alkaline or pH-neutral, preferably alkaline, cleaning composition, wherein in case of an acidic cleaning composition said composition is different from the acidic aqueous composition used in step 1).

### More Specifically, Prior to Step 1) the Following Optional Step can be Performed:

Step A-1): preferably alkaline cleaning and optionally subsequently rinsing the surface of the substrate.

Preferably, the method does not contain any step involving any treatment with chromium ions such as Cr(VI) and/or Cr(III) ions.

The optional rinsing being part of step A-1) is preferably performed by using deionized water or tap water. Preferably, the rinsing is performed by using deionized water.

### Substrate

The metallic surface of the is made at least partially of at least one kind of steel and/or zinc and/or of at least one alloy thereof. Preferably, the overall metallic surface is made at least partially of at least one kind of steel and/or zinc and/or of at least one alloy thereof. The term “alloy” refers to both steel alloys and zinc alloys. More preferably, the substrate as such is a metallic substrate made at least partially of at least one kind of steel and/or zinc and/or of at least one alloy thereof. Examples of steels are galvanized steels such as hot dip galvanized steel (HDG) and alloys of at least one kind of steel and zinc and/or magnesium. Examples of zinc alloys are zinc magnesium alloys. Preferably, the metallic surface does not comprise aluminum and/or an aluminum alloy in any amount exceeding the amount of the at least one kind of steel and/or zinc and/or of at least one alloy thereof present therein.

All kinds of substrates of different shapes and geometries can be used. Preferably, the substrate is selected from sheets and coils as well as parts, in particular parts suitable for use in the automotive industry, and mixtures thereof.

Preferably, the metal-plastic hybrid material consists of the substrate having at least one metallic surface made at least partially of steel and/or zinc and/or of at least one alloy thereof and the at least one thermoplastic material applied onto said metallic surface in step 3) and optional step 2). In particular, the metal-plastic hybrid material preferably does not comprise any further substrate having at least one metallic surface. Particularly, the metal-plastic hybrid material does not represent any sandwich structure, where the at least one thermoplastic material applied is sandwiched between two metallic surfaces.

### Step 1) of the Method

In step 1) an aqueous acidic composition is applied at least in portion onto the at least one metallic surface of the substrate to form a film at least in portion on said surface. An optional drying or curing of the film to form a dried or cured layer may be performed within step 1). Preferably, such a drying or curing is performed. Drying is preferably performed, e.g., at a temperature in the range of 15° C. to 100° C., more preferably at a temperature in the range of 18° C. to 95° C., in particular at a temperature in the range of 20° C. to 90° C.

Step 1) preferably is a contacting step, where the metallic surface is contacted with the aqueous acidic composition. “Contacting” includes a spraying, dip coating or roll coating procedure. “Contacting” may also be a flooding of the surface or even a manual wiping or brushing.

The treatment time, i.e., the period of time the surface is contacted with the acidic aqueous composition used in step 1) is preferably of from 15 seconds to 20 minutes, more preferably of from 30 seconds to 10 minutes, and most preferably of from 45 seconds to 5 minutes, as for example of from 1 to 3 minutes, preferably in each case when parts, in particular parts suitable for use in the automotive industry, are used as substrate. In case the substrate is a coil, the treatment time is preferably less than 1 minute, more preferably less than 30 or 15 seconds, even more preferably less than seconds, still more preferably in a range of from 1 to 5 seconds.

The temperature of the acidic aqueous composition used in step 1) is preferably of from 5 to 50° C., more preferably of from 15 to 45° C. and most preferably of from 25 to 40° C.

By performing step 1) preferably a conversion coating film is formed on the metallic surface. Preferably, a coating layer is preferably formed after drying or curing, preferably drying, that has a coating weight determined by XRF (X-ray fluorescence spectroscopy) of: 1 to 90 mg/m², more preferably 5 to 85 mg/m², still more preferably 10 to 80 mg/m², even more preferably 15 to 75 mg/m² of phosphor, in each case calculated as P₂O₅, in case of the presence of constituent a7) as defined hereinafter in the acidic aqueous composition. Preferably, a coating layer is preferably formed after drying or curing, preferably drying, that has a coating weight determined by XRF (X-ray fluorescence spectroscopy) of: 0.5 to 10 mg/m², more preferably 1 to 8 mg/m², still more preferably 1.5 to 7 mg/m², even more preferably 2 to 6 mg/m² of manganese, in each case calculated as metal, in case of the presence of constituent a4) as defined hereinafter in the acidic aqueous composition.

### Acidic Aqueous Composition

The acidic aqueous composition comprises, besides water, at least one water-soluble polymer having least one kind of functional groups selected from acid groups, hydroxyl groups, amino groups, and mixtures thereof as at least one constituent a1). All constituents present in the composition are different from each other.

Preferably, the acidic aqueous composition used in step 1) has a pH value in a range of from 0.1 to <7.0, more preferably of from 0.5 to 6.5, still more preferably of from 0.7 to 6.0, even more preferably of from 0.9 to 5.5, still more preferably of from 1.0 to 5.0, yet more preferably of from 1.2 to 4.5, still more preferably of from 1.5 to 4.0, even more preferably of from 1.7 to 3.5, most preferably of from 1.8 to 3.0. Preferably, the pH value is measured at room temperature (23° C.). The pH can be preferably adjusted by using phosphoric acid, aqueous ammonia and/or sodium carbonate if necessary. Most preferred, the pH value is in a range of from 2.0±0.5.

The term “aqueous” with respect to the acidic aqueous composition used in step 1) in the sense of the present invention preferably means that the composition is a composition containing at least 50 wt.-%, preferably at least 60 wt.-%, more preferably at least 70 wt.-%, in particular at least 80 wt.-%, most preferably at least 90 wt.-% of water, based on its total content of organic and inorganic solvents including water. Thus, the composition may contain at least one organic solvent besides water-however, in an amount lower than the amount of water present.

Preferably, the acidic aqueous composition used in step 1) contains at least 50 wt.-%, preferably at least 60 wt.-%, more preferably at least 70 wt.-%, in particular at least 80 wt.-%, most preferably at least 90 wt.-% of water, in each case based on its total weight.

The acidic aqueous composition can be used as a dip coat bath. However, it can also be applied by virtually any conventional coating procedure like, e.g., spray coating, roll coating, brushing, wiping etc. as outlined above in connection with step 1). Spraying or roll coating is preferred.

The acidic aqueous composition used in step 1) preferably is a solution.

Preferably, the acidic aqueous composition used in step 1) has a temperature in a range of from 18 to 35° C., more preferably of from 20 to 35° C., in particular of from 20 to 30° C.

Water-Soluble Polymer (Constituent a1))

The acidic aqueous composition comprises at least one water-soluble polymer having least one kind of functional groups selected from acid groups, hydroxyl groups, amino groups, and mixtures thereof as at least one constituent a1).

Solubility is determined at a temperature of 20° C. and atmospheric pressure (1.013 bar).

Preferably, the at least one water-soluble polymer used as constituent a1) is present in the acidic aqueous composition in an amount in a range of from 0.1 to 5.0 g/L, more preferably of from 0.3 to 4.5 g/L, even more preferably of from 0.5 to 4.0 g/L, still more preferably of from 0.7 to 3.5 g/L, yet more preferably of from 0.9 to 3.0 g/L, still more preferably of from 1.1 to 2.5 g/L, most preferably of from 1.3 to 2.0 g/L. Alternatively, the at least one water-soluble polymer used as constituent a1) is present in the acidic aqueous composition in an amount in a range of from 0.1 to 15.0 g/L, more preferably of from 0.3 to 12.0 g/L, even more preferably of from 0.5 to 11.0 g/L, still more preferably of from 0.7 to 10.0 g/L.

Preferably, the at least one water-soluble film-forming polymer used as constituent a1) has at least one kind of functional groups selected from carboxylic acid groups, phosphonic acid groups, sulfonic acid groups, hydroxyl groups, amino groups, and mixtures thereof, more preferably selected from carboxylic acid groups, hydroxyl groups, amino groups, and mixtures thereof, even more preferably selected from carboxylic acid groups.

Preferably, the at least one water-soluble polymer used as constituent a1) is a homopolymer or copolymer obtainable from polymerization of at least one kind of ethylenically unsaturated monomers, wherein at least part of said monomers bear at least one kind of functional groups selected from acid groups, hydroxyl groups, amino groups, and mixtures thereof, more preferably is a homopolymer or copolymer obtainable from polymerization of at least one kind of vinyl monomers and/or (meth)acrylic monomers, wherein at least part of said monomers bear at least one kind of functional groups selected from acid groups, hydroxyl groups, amino groups, and mixtures thereof. In particular in case of homopolymers and copolymers of vinyl phenol, it is possible to modify these polymers via a condensation reaction, in particular a Mannich reaction, with amino-group(s) bearing compounds such as ethanolamine and/or N-methyl glucamine.

Examples of monomers comprising an acid group are acrylic acid and methacrylic acid as well as maleic acid. Examples of monomers comprising a hydroxyl group are 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 3-phenoxy-2-hydroxypropyl (meth)acrylate, glycerol mono (meth)acrylate, N-(2-hydroxypropyl) (meth)acrylamide, allyl alcohol, hydroxystyrene, hydroxyalkyl vinyl ethers such as hydroxybutyl vinyl ether and vinylbenzyl alcohol, vinyl phenol and vinyl alcohol. Examples of further non-functional monomers, which can be additionally used and which in particular do not bear acid groups, hydroxyl groups, and mixtures thereof, are ethylene, propylene, butylene as well as (meth)acrylic esters of aliphatic C₁-C₃₀-monoalcohols, e.g., methyl (meth)acrylate, ethyl (meth)acrylate, n-propyl (meth)acrylate), i-propyl (meth)acrylate, n-butyl (meth)acrylate, i-butyl (meth)acrylate, t-butyl (meth)acrylate, lauryl (meth)acrylate, 2-ethylhexyl (meth)acrylate, 3-propylheptyl (meth)acrylate, stearyl (meth)acrylate, behenyl (meth)acrylate, benzyl (meth)acrylate, cyclohexyl (meth)acrylate and isobornyl (meth)acrylate. However, non-functional vinyl monomers are preferred, in particular over non-functional (meth)acrylic esters of aliphatic C₁-C₃₀-monoalcohols.

If polymer a1) is a homopolymer, it preferably is a poly(meth)acrylic acid. If polymer a1) is a copolymer and bears at least acid groups as functional groups, it preferably is a (meth)acrylic copolymer, which preferably comprises a polymeric backbone and at least one kind of side chains attached to said polymeric backbone, which bear acid groups such as carboxylic acid groups.

The term “(meth)acryl” means “acryl” and/or “methacryl”. Similarly, “(meth)acrylate” means acrylate and/or methacrylate, and “(meth)acrylic” means acrylic and methacrylic. A “(meth)acrylic polymer” is formed it least partially from “acrylic monomers” and/or “methacrylic monomers”, but additionally may contain non-acryl and non-methacryl monomeric units if other ethylenically unsaturated monomers such as vinyl monomers are additionally used in case polymer a1) is a copolymer. Preferably, the backbone of such a (meth)acrylic copolymer is formed from more than 50 mol-%, even more preferably of from more than 75 mol-%, of (meth)acrylic monomers.

Preferably, the at least one water-soluble polymer used as constituent a1) is selected from
(meth)acrylic acid homopolymers, in particular acrylic acid homopolymers,
copolymers of (meth)acrylic acid and at least one kind of ethylenically unsaturated monomers different from (meth)acrylic acid, in particular copolymers of (meth)acrylic acid and maleic acid,
copolymers of maleic acid and at least one kind of ethylenically unsaturated monomers different from maleic acid, in particular copolymers of maleic acid and ethylene and/or propylene and/or at least one kind of alkyl vinyl ethers such as methyl vinyl ether,
copolymers of vinyl phosphonic acid and at least one kind of ethylenically unsaturated monomers different from vinyl phosphonic acid, in particular copolymers of (meth)acrylic acid and vinyl phosphonic acid as well as copolymers of (meth)acrylic acid and vinyl phosphonic acid and maleic acid,
vinyl alcohol homopolymers,
copolymers of vinyl alcohol and at least one kind of ethylenically unsaturated monomers different from vinyl alcohol such as vinyl acetate,
vinyl phenol homopolymers,
copolymers of vinyl phenol and at least one kind of ethylenically unsaturated monomers different from vinyl phenol,
copolymers of vinyl mercaptoethanol and at least one kind of ethylenically unsaturated monomers different from vinyl mercaptoethanol, and
homopolymers and copolymers of vinyl phenol, which have been modified with at least one amine, preferably at least one primary amine such as N-ethanolamine and/or N-methyl glucamine, and mixtures thereof. The modification is preferably performed via a Mannich base reaction based on the condensation of formaldehyde with a primary or secondary amine.

More preferably, the at least one water-soluble polymer used as constituent a1) is selected from (meth)acrylic acid homopolymers, in particular acrylic acid homopolymers, copolymers of (meth)acrylic acid and at least one kind of ethylenically unsaturated monomers different from (meth)acrylic acid, in particular copolymers of (meth)acrylic acid and maleic acid, copolymers of maleic acid and at least one kind of ethylenically unsaturated monomers different from maleic acid, in particular copolymers of maleic acid and ethylene and/or propylene and/or at least one kind of alkyl vinyl ethers such as methyl vinyl ether, vinyl alcohol homopolymers, copolymers of vinyl alcohol and at least one kind of ethylenically unsaturated monomers different from vinyl alcohol, homopolymers and copolymers of vinyl phenol, which have been modified with at least one amine, preferably at least one primary amine or secondary amine such as N-ethanolamine and/or N-methyl glucamine, and mixtures thereof. Particularly preferable polymers are N-Methyl glucamine-modified poly(vinyl phenol), N-Ethanolamine-modified poly(vinyl phenol), poly(maleic acid-co-vinyl methyl ether), poly(maleic acid-co-acrylic acid), polyacrylic acid, poly(vinyl-phosphonic acid-co-acrylic acid), poly(acrylic acid-co-maleic acid-co-vinyl phosphonic acid), poly(acrylic acid-co-vinyl mercaptoethanol), poly(acrylic acid-co-maleic acid-co-vinyl mercaptoethanol) and mixtures thereof.

Preferably, the at least one water-soluble polymer has a weight average molecular weight (M_{w}) in a range of from 1,000 to 350,000 g/mol, preferably of from 2,000 to 325,000 g/mol, more preferably of from 3,000 to 300 000 g/mol, still more preferably of from 4,000 to 375,000 g/mol. The weight average molecular weight is determined by the method described hereinafter in the ‘methods’ section.

If a polymer a1) is used, which is a poly(meth)acrylic acid, in particular a polyacrylic acid, it preferably has a weight average molecular weight (M_{w}) in a range of from 10 000 to 350,000 g/mol, preferably of from 50,000 to 325,000 g/mol, more preferably of from 100,000 to 300 000 g/mol, still more preferably of from 150,000 or 200,000 to 375,000 g/mol. If a polymer a1) is used, which is a copolymer at least partially prepared from maleic acid, it preferably has a weight average molecular weight (M_{w}) in a range of from 10,000 to 200,000 g/mol, preferably of from 15,000 to 150,000 g/mol, more preferably of from 20,000 to 100,000 g/mol, still more preferably of from 30,000 to 80,000 g/mol. If a polymer a1) is used, which is a homopolymer or copolymer at least partially prepared from vinyl alcohol and/or vinyl phenol, it preferably has a weight average molecular weight (M_{w}) in a range of from 500 to 100,000 g/mol, preferably of from 750 to 50,000 g/mol, more preferably of from 1,000 to 25,000 g/mol, still more preferably of from 1,000 to 10,000 g/mol.

### Optional Constituent a2)

Preferably, the aqueous acidic composition used in step 1) further comprises zinc cations as at least one constituent a2), preferably in an amount in a range of from 0 to 8.0 g/L, more preferably of from 0.1 to 8.0 g/L, even more preferably of from 0.2 to 6.0 g/L, still more preferably of from 0.3 to 5.0 g/L, yet more preferably of from 0.5 to 3.0 g/L, in each case calculated as metal. Alternatively, the at least constituent a2) is present in the acidic aqueous composition in an amount in a range of from 0.1 to 50.0 g/L, more preferably of from 0.3 to 45.0 g/L, even more preferably of from 0.5 to 40.0 g/L, still more preferably of from 0.7 to 35.0 g/L.

The aqueous acidic composition may comprise further constituents as lined out in the hereinafter. The term “further comprises”, as used herein throughout the description in view of the ingredients of the aqueous compositions, means “in addition to the mandatory constituents. Therefore, such “further” constituents include ions different from the above-mentioned metal ions.

### Preferably,

(i) the aqueous acidic composition used in step 1) further comprises at least one of constituents a3) and a4), preferably both of a3) and a4) or only a4), namely
   at least one metal cation selected from the group of titanium, zirconium and hafnium ions, and mixtures thereof, preferably at least one metal cation selected from titanium and zirconium ions and mixtures thereof, as at least one constituent a3), preferably in an amount in a range of from 5 to 5000 ppm, more preferably of from 7.5 to 4000 ppm, still more preferably of from 10 to 3000 ppm, even more preferably of from 12.5 to 2000 ppm, yet more preferably of from 15 to 1000 ppm, in particular of from 17.5 to 500 ppm, more particularly of from 20 to 300 ppm, most preferably of from 30 to 200 ppm, in each case calculated as metal, and/or
   manganese cations as at least one constituent a4), preferably in an amount in a range of from 0 to 5.0 g/L or of from 0.1 to 5.0 g/L, more preferably of from 0.1 to 4.0 g/L, even more preferably of from 0.2 to 3.5 g/L, still more preferably of from 0.3 to 3.0 g/L, yet more preferably of from 0.5 to 2.5 g/L, in each case calculated as metal, or preferably in an amount in a range of from 0 to 30.0 g/L or of from 0.1 to 27.5 g/L, more preferably of from 0.1 to 25.0 g/L, even more preferably of from 0.2 to 22.5 g/L, in each case calculated as metal,
   and optionally further comprises
   free fluoride anions as at least one optional constituent a5), and/or
   at least one organosilane as optional constituent a6), preferably in an amount in a range of from 10 to 200 ppm.
or in that
(ii) the aqueous acidic composition used in step 1) further comprises, preferably in combination with a2), at least constituent a7), namely
   phosphate anions as at least one constituent a7), preferably in an amount in a range of from 1 to 150 g/L, more preferably of from 2.0 to 125 g/L, even more preferably of from 3.0 to 100 g/L, still more preferably of from 4.0 to 95 g/L, yet more preferably of from 5.0 or 7.5 to 90 g/L, in each case calculated as P₂O₅, or preferably in an amount in a range of from 1 to 200 g/L, more preferably of from 2.0 to 195 g/L, even more preferably of from 3.0 to 190 g/L, still more preferably of from 4.0 to 185 g/L, yet more preferably of from 5.0 or 7.5 to 180 g/L, in each case calculated as P₂O₅.
   and optionally further comprises
   manganese cations as at least one constituent a4), preferably in an amount in a range of from 0 to 5.0 g/L or of from 0.1 to 5.0 g/L, more preferably of from 0.1 to 4.0 g/L, even more preferably of from 0.2 to 3.5 g/L, still more preferably of from 0.3 to 3.0 g/L, yet more preferably of from 0.5 to 2.5 g/L, in each case calculated as metal, or preferably in an amount in a range of from 0 to 30.0 g/L or of from 0.1 to 27.5 g/L, more preferably of from 0.1 to 25.0 g/L, even more preferably of from 0.2 to 22.5 g/L, in each case calculated as metal,
wherein in case of (i) preferably no phosphate anions a7) are present and wherein the acidic aqueous composition in case of (ii) preferably is free or essentially free of free fluoride anions a5).

Most preferred is an aqueous acidic composition according to option (ii), which additionally comprises the at least one constituent a2) (zinc cations).

In case of option (i) the aqueous acidic composition used in step 1) preferably comprises the at least one constituent a3), said constituent a3) being preferably selected from titanium and zirconium ions and mixtures thereof, most preferably being selected from titanium ions. The content of constituent a3) can be monitored and determined by the means of ICP-OES (optical emission spectroscopy with inductively coupled plasma). Said method is described hereinafter in detail. Preferably, a precursor metal compound is used to generate the metal cations present as constituent a3) in the composition. Preferably, the precursor metal compound is water-soluble. Solubility is determined at a temperature of 20° C. and atmospheric pressure (1.013 bar). Particularly preferred zirconium, titanium and/or hafnium compounds are the complex fluorides of these metals. The term “complex fluoride” includes the single and multiple protonated forms as well as the deprotonated forms. It is also possible to use mixtures of such complex fluorides. Complex fluorides in the sense of the present invention are complexes of zirconium, titanium and/or hafnium formed with fluoride ions in the composition, e.g., by coordination of fluoride anions to zirconium, titanium and/or hafnium cations in the presence of water. Moreover, also the use of the carbonates and/or complex carbonates and/or lactates and/or in particular nitrates of zirconium, titanium and/or hafnium is possible. However, preferably, the cations are incorporated into the composition in form of their complex fluorides.

In case of option (i) the aqueous acidic composition used in step 1) preferably comprises manganese cations as a4). In this case, manganese as metal can be added to, e.g., phosphoric acid and a diluted version thereof containing manganese cations a4) (as well as phosphate anions a7)) can be included into the composition. It is also possible in case of option (ii) that manganese cations a4) are present.

In case of option (i) the aqueous acidic composition used in step 1) optionally and preferably comprises as at least one constituent a5) free fluoride anions. These may result from the presence of constituent a3), i.e., in particular when complex fluorides of Ti, Zr and/or Hf are present in the composition, but may also or alternatively result from the presence of other optional constituents as described hereinafter such as by incorporation of at least one water-soluble fluorine compound. Examples of such water-soluble fluorine compounds are fluorides (other than complex fluorides of Ti, Zr and/or Hf) as well as hydrofluoric acid. The free fluoride content is determined by means of a fluoride ion sensitive electrode according to the method disclosed in the ‘methods’ section.

Optionally, the acidic aqueous composition in case of option (i) used in step 1) further comprises at least one organosilane as optional constituent a6). Examples are, e.g., (3-aminopropyl) trimethoxysilane, (3-aminopropyl)triethoxysilane, N-2-aminoethyl-3-aminopropyltrimethoxysilane, (3-mercaptopropyl) trimethoxysilane, (3-mercaptopropyl)triethoxysilane, (3-glycidyloxypropyl) trimethoxysilane and/or (3-glycidyloxypropyl)triethoxysilane, and/or vinyltrimethoxysilane.

In case of option (ii) the aqueous acidic composition used in step 1) preferably comprises preferably in combination with a2), at least constituent a7), namely phosphate anions as at least one constituent a7). By using phosphate anions an amorphous zinc phosphate layer may be formed on the metallic surface. Phosphate anions are preferably added in the form of phosphoric acid.

### Additional Optional Constituents

Optionally, the aqueous acidic composition further comprises at least one kind of metal cations selected from the group of cations of metals of the 1^{st} to 3^{rd} subgroup (copper, zinc and scandium groups) and 5^{th} to 8^{th} subgroup (vanadium, chromium, manganese, iron, cobalt and nickel groups) of the periodic table of the elements including the lanthanides as well as the 2^{nd} main group of the periodic table of the elements (alkaline earth metal group), lithium, bismuth and tin. Preferably, however no metal cation of the chromium, cobalt and nickel groups is used. The before-mentioned metal cations are generally introduced in form of their water-soluble compounds, preferably as their water-soluble salts. Preferred cation(s) is/are selected from the group consisting of cations of cerium and the other lanthanides, iron, calcium, copper, magnesium, niobium, tantalum, yttrium, vanadium, lithium, bismuth, and tin.

Optionally, the aqueous acidic composition further comprises at least one pH-Value adjusting substance, preferably selected from the group consisting of nitric acid, sulfuric acid, methanesulfonic acid, acetic acid, aqueous ammonia, sodium hydroxide and sodium carbonate, wherein nitric acid, aqueous ammonia and sodium carbonate are preferred. Depending on the pH value of the acidic aqueous composition the above compounds can be in their fully or partially deprotonated form or in protonated forms.

Optionally, the aqueous acidic composition further comprises at least one complexing agent. An example is 1-Hydroxyethane-1,1-diphosphonic acid (HEDP).

Optionally, the aqueous acidic composition further comprises at least one corrosion inhibitor. Examples are L-cysteine and other amino acids, benzotriazole and mixtures thereof. Preferably, the at least one corrosion inhibitor does not comprise any kind of metal ions.

Optionally, the aqueous composition further comprises at least one organic acid, preferably at least one organic acid having at least two carboxylic acid groups and/or at least one organic acid having at least one carboxylic acid groups and at least one further functional group having at least one donor atom such an OH-group, e.g., lactic acid, in particular when the aqueous composition is alkaline. The presence of such a compound may be helpful for stabilization of the at least one metal ion in the composition such as Zr cations.

The aqueous composition may further comprise at least one of the following constituents: one or more waxes, one or more wetting agents and one or more defoamers.

### Optional Step 1a)

After step 1) the surface of the substrate obtained after contact according to step 1) can be optionally rinsed, preferably with deionized water or tap water (optional step 1a)). If this step is performed, it is preferably done prior to any drying or curing performed within step 1).

### Optional Step 2) of the Method and Step 3) of the Method

In an optional step 2) at least one thermoplastic polymeric material TM1 is applied in form of a foil at least in portion onto the film or onto the dried or cured layer obtained after step 1) (or after optional step 1a)).

The formed foil obtained from using thermoplastic polymeric material TM1 in optional step 2) preferably serves as compatibilizer material for an optionally subsequent injected thermoplastic polymeric material TM2 in step 3). Preferably, optional step 2) is not performed by injection molding. Preferably, a foil made of the at least one thermoplastic polymeric material TM1 is applied at least in portion onto the film or onto the dried or cured layer obtained after step 1) (or after optional step 1a).

Preferably, optional step 2) is not performed. If optional step 2) is performed, the thermoplastic polymeric material TM1 is preferably different form thermoplastic polymeric material TM2.

In step 3) at least one thermoplastic polymeric material TM2, which is identical to or different from the thermoplastic material TM1 optionally applied in step 2), and which is present in molten state, is applied at least in portion onto the film or onto the dried or cured layer obtained after step 1) or onto the foil optionally obtained after step 2) to form the metal-plastic hybrid material.

Step 3) is an injection molding step, where the thermoplastic polymeric material TM2 is injected preferably directly onto the metallic surface of the substrate, to which prior to that the acidic aqueous composition has been applied in step 1).

Optional step 2) and/or step 3) can be performed in a continuous or discontinuous manner.

The substrate obtained after step 1) or after optional step 1a) is preferably heated before optional step 2) or before step 3) is performed, preferably heated to a temperature above the melting temperature of the respective thermoplastic material used.

Preferably, thermoplastic polymeric material TM1 used in optional step 2) and/or the thermoplastic polymeric material TM2 used in step 3) is applied in a manner such that a vacuum is applied to contact the respective thermoplastic polymeric material with at least a portion, but preferably with the entire surface of the substrate, which surface had been contacted with the acidic aqueous composition within step 1), and to remove air enclosed between the surface of the substrate and the respective thermoplastic polymeric material. Preferably, the temperature of the substrate and the respective thermoplastic polymeric material applied thereto is held above a temperature, at which the connection of the applied thermoplastic polymeric material and the metal substrate is promoted. After the aforementioned heating, the substrate is preferably placed into a device in which the respective thermoplastic polymeric material can be placed on the surface of the substrate, preferably a thermoforming device: e.g., in which the thermoplastic polymeric material TM1 can be applied as a foil. As an alternative, it is also possible to firstly place the substrate into the device, in which the respective thermoplastic polymeric material is going to be applied and then heat the substrate before placing the respective thermoplastic polymeric material on it. Preferably, after the heated substrate is placed in the device or after the substrate is placed in the device and then heated, the respective thermoplastic polymeric material is placed on the substrate and optionally heated, such as in case of step 3), where the material in injected in a molten state. If the respective thermoplastic polymeric material is heated, the heating can be, e.g., carried out by infrared radiation.

The temperature to which the respective thermoplastic polymeric material is heated preferably is selected such that the thermoplastic material is rubbery elastic. For this purpose, the thermoplastic material preferably is heated to a temperature above the glass transition temperature of the thermoplastic material, if the thermoplastic material is an amorphous thermoplast, or above the crystallite melting temperature, if the thermoplastic material is a semi-crystalline thermoplast, but preferably below the melting temperature to avoid any damage. After having placed the respective thermoplastic polymeric material on the surface of the substrate and optionally after having heated the material, a vacuum is preferably applied as described hereinbefore. By applying the vacuum, the respective thermoplastic polymeric material is preferably attached to the surface of the substrate and a strong connection can be achieved. Removing the air which may be enclosed between the surface of the substrate and the respective thermoplastic polymeric material preferably results in a smooth surface without blisters. For applying the vacuum, the substrate may comprise openings through which air can be withdrawn. If the substrate should not have any openings, it is also possible to withdraw the air between the substrate and the respective thermoplastic polymeric material at the edges of the thermoplastic polymeric material. If the air is withdrawn at the edges, it is preferred to withdraw the air at least at two opposite sides and preferably over the whole circumference of the respective thermoplastic polymeric material. For applying the vacuum, any suitable vacuum pump can be used. If the air is withdrawn at the edges of the respective thermoplastic polymeric material, the respective thermoplastic polymeric material is preferably fixed such in a device for applying the vacuum, that a gap is formed between the substrate and the edge of the respective thermoplastic polymeric material and the vacuum is applied through that gap. By applying the vacuum, the respective thermoplastic polymeric material preferably contacts the substrate uniformly over its entire surface and, thus, a uniform layer is formed on the surface of the substrate.

After having contacting the respective thermoplastic polymeric material with the preferably entire surface of the substrate, the temperature of the substrate and the respective thermoplastic polymeric material is preferably held at the temperature at which the connection of the thermoplastic material and the substrate is promoted, preferably at a temperature above the melting temperature of the thermoplastic material. By holding the temperature, the thermoplastic material preferably reacts chemically at least with the functional groups water-soluble polymer originally present in the acidic aqueous composition, by which a stable connection of the surface of the substrate and the respective thermoplastic polymeric material is achieved and a composite component comprising a “metal layer” (metallic surface of the substrate) and “polymer layer” (applied thermoplastic material) is formed.

Preferably, at least prior to performing step 3) the substrate obtained after step 1), optionally 1a) or optionally step 2) is placed into a mold before step 3) is carried out.

### Thermoplastic Polymeric Materials TM1 and TM2

Thermoplastic polymeric material TM2 may be identical to or different from thermoplastic material TM1, preferably is different therefrom.

Preferably, each of the thermoplastic polymeric materials TM1 and TM2 is able to chemically bind to the functional groups of the water-soluble polymer originally present in the acidic aqueous composition used in step 1).

Preferably, thermoplastic polymeric material TM2 is selected from polyamides, polyesters such as PET and/or PBT, polyurethanes, polycarbonates, polyolefins such as polypropylenes and polyethylenes, as well as mixtures thereof. It is possible to use recycled thermoplastic polymeric materials such as recycled polyamides. Most preferred are polyamides. Preferably, the polyamides are selected from PA6, PA66, PA66/6, PA6.10, PA6.12, PA12, PA9T, PA6I/6T, PA6T/6I, PA6/6.36 and combinations thereof. Preferably, at least one polyamide is applied via step 3) as the at least one thermoplastic polymeric material TM2.

It is possible to use the thermoplastic polymeric material TM1 and/or TM2, preferably TM2, such as polyamides in a form, where it has been compounded with at least one additive such as at least one rubber such as EPDM (ethylene propylene diene monomer) rubber, in particular to improve the properties of the thermoplastic polymeric material such as to reduce its water uptake. Alternatively or additionally, the thermoplastic polymeric material TM1 and/or TM2, preferably TM2 may optionally comprise (i) at least one kind of fiber such as glass fibers, carbon fibers, aramid fibers and combinations thereof, and/or may optionally comprise (ii) a polyether block polyamide such as copolymerisates of polyether diamines and aliphatic C₄ to C₄₀ dicarboxylic acids and/or C₆ to C₁₂ lactams like caprolactam or lauryllactam, copolymerisates of aliphatic C₄ to C₁₀ diamines and aliphatic C₄ to C₄₀ dicarboxylic acids, polycondensates of C₆ to C₁₂ lactams, copolymerisates of lactams and/or aliphatic dicarboxylic acids and aliphatic diamines and combinations thereof, and/or may optionally comprise (iii) at least one impact modifier like maleic anhydride grafted copolymers of ethylene and at least one of alpha-olefins, (meth)acrylic acid esters, and (meth)acrylic acid, copolymers of maleic anhydride and at least one of ethylene and (meth)acrylic acid esters, styrene maleic anhydride or maleic anhydride grafted polypropylene.

Preferably, thermoplastic polymeric material TM1 is selected from polyamides, polyesters such as PET and/or PBT, polyurethanes, polycarbonates, polyolefins such as polypropylenes and polyethylenes, as well as mixtures thereof. It is possible to use recycled thermoplastic polymeric materials such as recycled polyamides. Preferably, the polyamides are selected from PA6, PA66, PA66/6, PA6.10, PA6.12, PA12, PA9T, PA6I/6T, PA6T/6I, PA6/6.36 and combinations thereof. Most preferred are polyolefins. Preferably, at least one polyolefin is applied via optional step 2) as the at least one thermoplastic polymeric material TM1.

Preferably, thermoplastic polymeric material TM1 has a melting temperature in a range of from 80° C. to 280° C. For example, polyolefins may have a melting temperature of 80° C., whereas polyamides have a significantly higher melting temperature of, e.g., 280° C.

Preferably, thermoplastic polymeric material TM2 has a melting temperature in a range as defined for thermoplastic polymeric material TM1.

### Metal-Plastic Hybrid Material Obtainable by the Inventive Method

A further subject-matter of the present invention is a metal-plastic hybrid material obtainable by the inventive method.

All preferred embodiments described above herein in connection with the inventive method and preferred embodiments thereof are also preferred embodiments of the inventive metal-plastic hybrid material obtainable by said method.

Preferably, the metal-plastic hybrid material does not have a sandwich structure, wherein the metallic surface of the substrate, preferably the substrate as such, is sandwiched between two thermoplastic materials. Hence, preferably, the inventive method does not comprise any step, wherein any thermoplastic polymeric material is applied on the metallic surface of the substrate opposite to the metallic surface, in particular not in the form of a foil, to which the thermoplastic polymeric material TM2 has been applied to in step 3).

Preferably, the dry layer thickness of a layer obtained from drying or curing the film obtainable from applying the aqueous acidic composition, as defined in connection with aforementioned step 1) of the inventive method, at least in portion onto said metallic surface, is in a range of from 100 to 1000 nm, more preferably of from 150 to 750 nm, in particular of from 250 to 550 nm.

### Use of the Water-Soluble Polymer and the Acidic Aqueous Composition

A further subject-matter of the present invention is a use of the water-soluble polymer as defined hereinbefore as constituent a1) of the acidic aqueous composition, preferably a use of said water-soluble polymer when present in said acidic aqueous composition as defined in connection with aforementioned step 1) of the inventive method, for adhering a metallic surface made at least partially of steel and/or zinc and/or of at least one alloy thereof of a substrate to a thermoplastic polymeric material present on said surface in form of a foil or applied onto said surface by injection molding, preferably by making use of the inventive method.

All preferred embodiments described above herein in connection with the inventive method, the inventive metal-plastic hybrid material obtainable by said method, and preferred embodiments thereof are also preferred embodiments of the inventive use.

### Metal-Plastic Hybrid Material

A further subject-matter of the present invention is a metal-plastic hybrid material as such, i.e., a metal-plastic hybrid material comprising
a substrate having at least one metallic surface, which is made at least partially of at least one kind of steel and/or zinc and/or of at least one alloy thereof,
a film or a dried or cured layer applied at least in portion over said metallic surface, the film or dried or cured layer being obtainable from applying the aqueous acidic composition, as defined in connection with aforementioned step 1) of the inventive method, at least in portion onto said metallic surface,
optionally at least one thermoplastic polymeric material TM1 in form of a foil applied at least in portion over the film or the dried or cured layer, preferably as defined in optional step 2) of the inventive method, and
at least one thermoplastic polymeric material TM2 in a form obtainable from an injection molding and applied at least in portion over the film or over the dried or cured layer or, if present, over the foil, preferably as defined in step 3) of the inventive method, the material TM2 being identical to or different from the optionally present thermoplastic polymeric material TM1.

Preferably, the metal-plastic hybrid material is obtainable by the inventive method. Preferably, the metal-plastic hybrid material is a laminate.

Preferably, the thermoplastic polymeric material TM2 being present in a form obtainable from an injection molding, has a total thickness in a range of from 200 to 800 μm.

All preferred embodiments described above herein in connection with the inventive method, the inventive metal-plastic hybrid material obtainable by said method, the inventive use, and preferred embodiments thereof, are also preferred embodiments of the inventive metal-plastic hybrid material as such.

Preferably, the film or a dried or cured layer, preferably the dried or cured, preferably dried, layer applied at least in portion over the metallic surface of the metal-plastic hybrid material has a coating weight determined by XRF (X-ray fluorescence spectroscopy) of: 1 to 90 mg/m², more preferably 5 to 85 mg/m², still more preferably 10 to 80 mg/m², even more preferably 15 to 75 mg/m², of phosphor, in each case calculated as P₂O₅, in case of the presence of constituent a7) as defined hereinafter in the acidic aqueous composition. Preferably, the layer formed after drying or curing, preferably drying, has a coating weight determined by XRF (X-ray fluorescence spectroscopy) of: 0.5 to 10 mg/m², more preferably 1 to 8 mg/m², still more preferably 1.5 to 7 mg/m², even more preferably 2 to 6 mg/m² of manganese, in each case calculated as metal, in case of the presence of constituent a4) as defined hereinafter in the acidic aqueous composition.

### Use of the Metal-Plastic Hybrid Material

A further subject-matter of the present invention is a use of said metal-plastic hybrid material or of the metal-plastic hybrid material obtainable by the inventive method as component in the automotive or construction industry.

All preferred embodiments described above herein in connection with the inventive method, the inventive metal-plastic hybrid material obtainable by said method, the aforementioned inventive use, the inventive metal-plastic hybrid material as such, and preferred embodiments thereof, are also preferred embodiments of the inventive use of the metal-plastic hybrid material.

In particular, the metal-plastic hybrid material can be used for the manufacture of automotive parts, in particular, where weight reduction is needed. Further possible uses include battery housing and battery covers as well as the manufacture of panel controls in cars.

### Methods

### 1. Tensile Adhesion Strength

Tensile adhesion strength was measured by a pull-off test according to ISO 4624:2016. For the pull-off tests a T-joint configuration was used.

2. Determination of Average Molecular Weights M_{w} and Mₙ

The number average and weight average molecular weights (Mₙ and M_{w}), respectively, are measured according to the following protocol: Samples are analyzed by SEC (size exclusion chromatography) equipped with a MALS detector. Absolute molar masses are obtained with a dn/dC value chosen equal to 0.1875 mL/g in order to get a recovery mass around 90%. Polymer samples are dissolved in the mobile phase and the resulting solutions are filtrated with a Millipore filter 0.45 μm. Eluting conditions are the following ones. Mobile phase: H₂O 100% vol. 0.1 M NaCl, 25 mM NaH₂PO₄, 25 mM Na₂HPO₄; 100 ppm NaN₃; flow rate: 1 mL/min; columns: Varian Aquagel OH mixed H, 8 μm, 3*30 cm; detection: RI (concentration detector Agilent)+MALLS (Multi Angle Laser Light Scattering) Mini Dawn Tristar+UV at 290 nm; samples concentration: around 0.5 wt % in the mobile phase; injection loop: 100 μL. Polydispersity P can be calculated from the M_{w} and Mₙ values obtained.

### 3. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 4. ICP-OES

The amounts of certain elements in a sample under analysis, such as of zirconium, titanium, hafnium etc., is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength and is analyzed using an optical system. There is a linear relation between the intensity of the light emitted and the concentration of the element in question. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

### EXAMPLES

The following examples further illustrate the invention but are not to be construed as limiting its scope.

### 1. Preparation of Acidic Aqueous Coating Compositions

1.1 A number of acidic aqueous compositions A1 to A5 (inventive) and a composition A6 (comparative) have been prepared (1 L each). All compositions were chromium-free. Each of the compositions A1 to A5 contained one of the following water-soluble polymers P1 to P5:
P1 Commercially available polyacrylic acid having a M_{w} of >150,000 g/mol,
P2: Blend of P1 and a copolymer of maleic acid and acrylic acid,
P3: N-ethanolamine modified polyvinylphenol,
P4: Copolymer of maleic acid and ethylene, and
P5: Copolymer of maleic acid and vinyl methyl ether.

TABLE 1

| | | | Amount of | | |
|---|---|---|---|---|---|
| | | | phosphate, | | |
| | | Amount of | calculated | Amount | Amount |
| | | polymer | as P₂O₅ | of Mn | of Zn |
| Composition | pH value | [g/L] | [g/L] | [g/L] | [g/L] |
| A1 | 2.0 | P1: 4.0 | 7.15 | 0.85 | 1.45 |
| A2 | 2.0 | P2: 4.0 | 3.58 | 0.43 | 0.73 |
| A3 | 2.0 | P3: 4.0 | 1.56 | 0.19 | 0.32 |
| A4 | 2.0 | P4: 8.0 | 3.58 | 0.43 | 0.73 |
| A5 | 2.0 | P5: 0.5 | 3.58 | 0.43 | 0.73 |
| A6 | 2.0 | — | 3.58 | 0.43 | 0.73 |

1.2 A number of acidic aqueous compositions B1 to B7 (inventive) and a composition B8 (comparative) have been prepared (1 L each). All compositions were chromium-free. Each of the compositions B1 to B7 contained one of the water-soluble polymers P1, P2, P4 or P5 as mentioned above:

TABLE 2

| | | | Amount of | | |
|---|---|---|---|---|---|
| | | | phosphate, | | |
| | | Amount of | calculated | Amount | Amount |
| | | polymer | as P₂O₅ | of Zn | of Mn |
| Composition | pH value | [g/L] | [g/L] | [ppm] | [ppm] |
| B1 | 2.6 | P1: 4.0 | 3.58 | 0.71 | 0.42 |
| B2 | 2.6 | P4: 4.0 | 3.58 | 0.71 | 0.42 |
| B3 | 2.6 | P5: 4.0 | 3.58 | 0.71 | 0.42 |
| B4 | 2.6 | P2: 4.0 | 3.58 | 0.71 | 0.42 |
| B5 | 2.3 | P1: 2.0 | 34 | 6.75 | 4.0 |
| B6 | 2.0 | P1: 8.0 | 136 | 27.0 | 16.0 |
| B7 | 2.0 | P1: 10.0 | 180 | 35.1 | 21.1 |
| B8 | 2.6 | — | 3.58 | 0.71 | 0.42 |

### 2. Pretreatment

A hot-dip galvanized steel substrate (substrate T1, Gardobond® panel MBZ automotive quality) has been used in form of a metal sheet.

The substrate was cleaned by making use of the commercial alkaline product Gardoclean® S 5160 (at 60 to 70° C.). Then, rinsing with tap water was performed and, subsequently, with deionized water (for 30 seconds each).

Then a contacting step was carried out, i.e., the surface of the substrate was contacted with one of the acidic aqueous compositions A1 to A6 or B1 to B8 described hereinbefore in item 1. in order to form a conversion coating layer on the surface of the substrate with adhesion promoting properties. The contacting step was performed in each case for 60 seconds by spraying of one of the acidic aqueous compositions onto the surfaces of the substrates. The acidic aqueous compositions were heated to 25° C. before spraying or applied by a roll coater.

Following the contacting step, a drying step is performed (15 minutes at 60 to 70° C.) after a period of air blowing. The resulting dry layer thickness was in a range of from 50 to 200 nm.

### 3. Preparation of Metal-Plastic Hybrid Materials

Polyamide 6 (PA6; commercial product Ultramid® B27) as thermoplastic polymeric material was compounded with a rubber material and various standard additives to produce Ultramid® B3Z8 in order to reduce the water uptake of polyamide. Before using the polyamide, it was placed into an oven before application to result in a “dry” polyamide. The resulting compounded PA6 was then applied by injection molding directly onto preheated surfaces of the substrates obtained after the pretreatment as described in item 2. The resulting laminates produced by injection molding had a thickness (of the plastic layer) in a range of from 200 to 800 μm.

### 4. Properties of the Obtained Metal-Plastic Hybrid Materials

A number of properties of the products obtained by the method described hereinbefore in item 3. have been investigated. These properties were determined according to the test methods described hereinbefore. The results are displayed in Tables 2a to 2b. In particular, the adhesion strength was investigated.

TABLE 2a

| Metal plastic hybrid material | Adhesion strength, |
|---|---|
| obtained from making use of | “dry” |
| composition | [MPa] |
| A1 | 8.32 |
| A2 | 11.70 |
| A3 | 11.15 |
| A4 | 10.45 |
| A5 | 12.80 |
| A6 | 0 |

TABLE 2b

| Metal plastic hybrid material | Adhesion strength, |
|---|---|
| obtained from making use of | “dry” |
| composition | [MPa] |
| B1 | 10.00 |
| B2 | 10.40 |
| B3 | 10.34 |
| B4 | 10.60 |
| B5 | 10.65 |
| B6 | 8.20 |
| B7 | 11.25 |
| B8 | 0 |

The thermoplastic has been injected on a specific surface area and the adhesion strength has been compared between the different compositions. Surprisingly, the pull off test show that a minimal strength has been obtained.

It was found that no adhesion, i.e., an only insufficient adhesion strength, was observed between the plastic layer and the steel substrate in the cases, when no polymer had been present in the aqueous acidic composition used (i.e., when compositions A6 and B8 had been used).

1. A method for preparing a metal-plastic hybrid material, said material comprising a substrate having at least one metallic surface and at least one thermoplastic material applied onto said metallic surface of the substrate, the method comprising at least steps 1) and 3) and optionally step 2):
1) applying an aqueous acidic composition at least in portion onto the at least one metallic surface of the substrate to form a film at least in portion on said surface,
wherein the metallic surface is made at least partially of at least one kind of steel and/or zinc and/or of at least one alloy thereof, and
wherein the acidic aqueous composition comprises, besides water, at least one water-soluble polymer having least one kind of functional group selected from the group consisting of acid groups, hydroxyl groups, amino groups, and mixtures thereof as at least one constituent a1),
and optionally drying or curing the film to form a dried or cured layer,
2) optionally applying at least one thermoplastic polymeric material TM1 in form of a foil at least in portion onto the film or onto the dried or cured layer obtained after step 1), and
3) injecting at least one thermoplastic polymeric material TM2, which is identical to or different from the thermoplastic material TM1 optionally applied in step 2), and which is present in molten state, at least in portion onto the film or onto the dried or cured layer obtained after step 1) or onto the foil optionally obtained after step 2) to form the metal-plastic hybrid material.

2. The method according to claim 1, wherein the acidic aqueous composition used in step 1) has a pH value in a range of from 0.1 to <7.0.

3. The method according to claim 1, wherein the at least one water-soluble polymer used as constituent a1) is present in the acidic aqueous composition in an amount in a range of from 0.1 to 5.0 g/L.

4. The method according to claim 1, wherein the at least one water-soluble polymer used as constituent a1) has at least one kind of functional group selected from the group consisting of carboxylic acid groups, phosphonic acid groups, sulfonic acid groups, hydroxyl groups, amino groups, and mixtures thereof.

5. The method according to claim 1, wherein the at least one water-soluble polymer used as constituent a1) is a homopolymer or copolymer obtained from polymerization of at least one kind of ethylenically unsaturated monomers, wherein at least part of said monomers bear at least one kind of functional group selected from the group consisting of acid groups, hydroxyl groups, amino groups, and mixtures thereof.

6. The method according to claim 1, wherein at least one water-soluble polymer used as constituent a1) is selected from the group consisting of (meth)acrylic acid homopolymers, acrylic acid homopolymers, copolymers of (meth)acrylic acid and at least one kind of ethylenically unsaturated monomers different from (meth)acrylic acid, copolymers of (meth)acrylic acid and maleic acid, copolymers of maleic acid and at least one kind of ethylenically unsaturated monomers different from maleic acid, copolymers of maleic acid and ethylene and/or propylene and/or at least one kind of alkyl vinyl ethers, copolymers of maleic acid and methyl vinyl ether, copolymers of vinyl phosphonic acid and at least one kind of ethylenically unsaturated monomers different from vinyl phosphonic acid, copolymers of (meth)acrylic acid and vinyl phosphonic acid, copolymers of (meth)acrylic acid and vinyl phosphonic acid and maleic acid, vinyl alcohol homopolymers, copolymers of vinyl alcohol and at least one kind of ethylenically unsaturated monomers different from vinyl alcohol, vinyl phenol homopolymers, copolymers of vinyl phenol and at least one kind of ethylenically unsaturated monomers different from vinyl phenol, copolymers of vinyl mercaptoethanol and at least one kind of ethylenically unsaturated monomers different from vinyl mercaptoethanol, homopolymers and copolymers of vinyl phenol and/or vinyl alcohol, that have been modified with at least one amine, homopolymers and copolymers of vinyl phenol and/or vinyl alcohol that have been modified with at least one primary amine, homopolymers and copolymers of vinyl phenol and/or vinyl alcohol that have been modified with N-ethanolamine and/or N-methyl glucamine, and mixtures thereof.

7. The method according to claim 1, wherein at least one water-soluble polymer used as constituent a1) is selected from the group consisting of (meth)acrylic acid homopolymers, acrylic acid homopolymers, copolymers of (meth)acrylic acid and at least one kind of ethylenically unsaturated monomers different from (meth)acrylic acid, copolymers of (meth)acrylic acid and maleic acid, copolymers of maleic acid and at least one kind of ethylenically unsaturated monomers different from maleic acid, copolymers of maleic acid and ethylene and/or propylene and/or at least one kind of alkyl vinyl ethers, copolymers of maleic acid and methyl vinyl ether, vinyl alcohol homopolymers, copolymers of vinyl alcohol and at least one kind of ethylenically unsaturated monomers different from vinyl alcohol, homopolymers and copolymers of vinyl phenol and/or vinyl alcohol, that have been modified with at least one amine, homopolymers and copolymers of vinyl alcohol that have been modified with at least one primary amine, homopolymers and copolymers of vinyl alcohol that have been modified with N-ethanolamine and/or N-methyl glucamine, and mixtures thereof.

8. The method according to claim 1, wherein the aqueous acidic composition used in step 1) further comprises zinc cations as at least one constituent a2).

9. The method according to claim 1, wherein
(i) the aqueous acidic composition used in step 1) further comprises at least one of constituents a3) and a4):
at least one metal cation selected from the group consisting of titanium, zirconium and hafnium ions, and mixtures thereof, or
manganese cations as at least one constituent a4),
and optionally further comprises
free fluoride anions as at least one optional constituent a5), and/or
at least one organosilane as optional constituent a6), or
(ii) the aqueous acidic composition used in step 1) further comprises at least constituent a7):
phosphate anions as at least one constituent a7),
and optionally further comprises manganese cations as at least one constituent a4).

10. The method according to claim 1, wherein the at least one thermoplastic polymeric material TM1 and the at least one thermoplastic polymeric material TM2 are independently selected from the group consisting of polyamides, polyesters, polyethylene terephthalate (PET), polybutylene terephtalate (PBT), polyurethanes, polycarbonates, polyolefins, polypropylenes, polyethylenes, and mixtures thereof.

11. A metal-plastic hybrid material obtained by the method according to claim 1.

12. A method of using a water-soluble polymer, wherein the water-soluble polymer has at least one kind of functional group selected from the group consisting of acid groups, hydroxyl groups, amino groups, and mixtures thereof, the method comprising using the water-soluble polymer as at least one constituent a1) of an acidic aqueous composition for adhering a metallic surface made at least partially of at least one kind of steel and/or zinc and/or of at least one alloy thereof of a substrate to a thermoplastic polymeric material present on said surface in form of a foil or applied onto said surface by injection molding.

13. The metal-plastic hybrid material of claim 11, wherein the at least one thermoplastic polymeric material TM1 is applied in form of a foil, the metal-plastic hybrid material further comprising
at least one thermoplastic polymeric material TM2 in a form obtained from an injection molding and applied at least in portion over the film or over the dried or cured layer or, if present, over the foil, the material TM2 being identical to or different from the optionally present thermoplastic polymeric material TM1.

14. The metal-plastic hybrid material according to claim 11, wherein the film or dried or cured layer, being obtained from applying the aqueous acidic composition, has a dry layer thickness in a range of from 100 to 1000 nm and/or in that the film or dried or cured layer, being obtainable from applying the aqueous acidic composition, has a coating weight determined by XRF (X-ray fluorescence spectroscopy) of: 1 to 90 mg/m², calculated as P₂O₅, in case of the presence of constituent a7) as defined herein after in the acidic aqueous composition, and/or of 0.5 to 10 mg/m², calculated as metal, in case of the presence of constituent a4) as defined hereinafter in the acidic aqueous composition.

15. A method of using the metal-plastic hybrid material according to claim 11, the method comprising using the metal-plastic hybrid as a component in the automotive or construction industry.

16. The method according to claim 1, wherein the acidic aqueous composition used in step 1) has a pH value in a range of from 0.5 to 6.5.

17. The method according to claim 1, wherein at least one water-soluble polymer used as constituent a1) is present in the acidic aqueous composition in an amount in a range of from 0.3 to 4.5 g/L.

18. The method according to claim 1, wherein at least one water-soluble polymer used as constituent a10 has at least one kind of functional group selected from the group consisting of carboxylic acid groups, hydroxyl groups, amino groups, and mixtures thereof.

19. The method according to claim 1, wherein the at least one water-soluble polymer used as constituent a1) is a homopolymer or copolymer obtained from polymerization of at least one kind of ethylenically unsaturated monomers, wherein at least part of said monomers bear at least one kind of functional group selected from the group consisting of homopolymers or copolymers obtained from polymerization of at least one kind of vinyl monomers and/or (meth)acrylic monomers.

20. The method according claim 1, wherein at least one water-soluble polymer used as constituent a1) is selected from the group consisting of N-Methyl glucamine-modified poly(vinyl phenol), N-ethanolamine-modified poly(vinyl phenol), poly(maleic acid-co-vinyl methyl ether), poly(maleic acid-co-acrylic acid), polyacrylic acid, poly(vinyl-phosphonic acid-co-acrylic acid), poly(acrylic acid-co-maleic acid-co-vinyl phosphonic acid), poly(acrylic acid-co-maleic acid-co-vinyl mercaptoethanol), and mixtures thereof.
